(19) United States
(12) Patent Application Publication
(10) Pub. No.: US 2014/0209203 A1
(43) Pub. Date: Jul. 31, 2014

(54) CONTAINER CONSTRUCTION FOR DISPENSING INTO A FUEL RECEPTACLE

(71) Applicant: TECHNICAL CHEMICAL COMPANY, Cleburne, TX (US)

(72) Inventors: Newton H. DUDLEY, Blum, TX (US); John A. MCDERMOTT, Arlington, TX (US)

(21) Appl. No.: 14/244,317

(22) Filed: Apr. 3, 2014

Related U.S. Application Data
(63) Continuation-in-part of application No. 13/106,442, filed on May 12, 2011.

(51) Int. Cl. B67D 3/00

(52) U.S. Cl. CPC B67D 3/0061
USPC 141/1; 141/350

(57) ABSTRACT

A container for dispensing into a fuel receptacle can include a neck through which a product is flowed, and threads which merge with a circumferentially continuous shoulder spaced apart from the neck. The neck disengages a lock which secures a closure of the fuel receptacle, in response to insertion of the container into the fuel receptacle. Another container can include a neck through which a product is flowed, and threads which merge with a circumferentially continuous shoulder spaced apart from the neck, the shoulder having a circumferentially continuous surface that faces an annular recess separating the shoulder from the neck. A method of discharging a fuel additive into a fuel receptacle is also disclosed.

### CROSS-REFERENCE TO RELATED APPLICATION

The present application is a continuation-in-part of prior application Ser. No. 13/106442, filed on 12 May 2011. The entire disclosure of this prior application is incorporated herein by this reference.

### BACKGROUND

This disclosure relates generally to equipment utilized and operations performed in conjunction with fuel systems and, in an example described below, more particularly provides a system for introducing a fuel additive into a fuel system.

It can be beneficial to provide a fuel receptacle with a closure, so that fuel vapors do not escape from a fuel reservoir, and so that debris, water, etc., cannot enter the fuel reservoir. A lock can be used to prevent inadvertent displacement of the closure.

However, the closure will also prevent introduction of a fuel additive (for example, an octane booster, a fuel injector or carburetor cleaner, a lubricant, etc.) into the fuel reservoir. Therefore, it will be appreciated that a need exists for improvements in the art of constructing containers for dispensing substances into a fuel receptacle.

### BRIEF DESCRIPTION OF THE DRAWINGS

FIG. 1 is a representative cross-sectional view of a fuel receptacle which can embody principles of the present disclosure.

FIG. 2 is a representative cross-sectional view of the fuel receptacle, taken along line 2-2 of FIG. 1.

FIG. 3 is a representative cross-sectional view of a fuel additive system and associated method, which system and method can embody the principles of this disclosure.

FIG. 4 is a representative cross-sectional view of a container which may be used in the system and method of FIG. 3.

FIG. 5 is a representative enlarged scale detail view of a portion of the FIG. 4 container.

FIG. 6 is a representative elevational view of another configuration of the container.

FIG. 7 is a representative enlarged scale elevational view of a thread portion of the FIG. 6 container.

### DETAILED DESCRIPTION

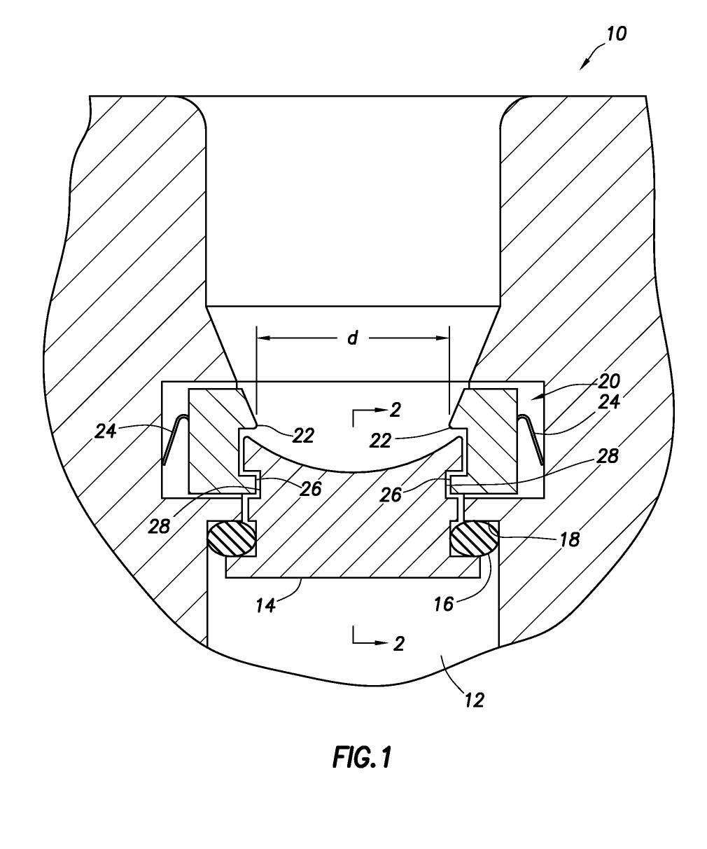

Representatively illustrated in FIG. 1 is a fuel receptacle 10 which can embody principles of this disclosure. In the example depicted in FIG. 1, a fuel entry passage 12 is blocked by a closure 14.

The closure 14 includes a seal 16 which engages a seat 18 to thereby prevent fluid flow through the passage 12. The closure 14 is maintained in its FIG. 1 closed position by means of a lock 20.

The lock 20 in this example includes laterally spaced apart latch members 22. The latch members 22 are biased inward toward each other by springs 24.

The springs 24 maintain engagement between a projection 26 formed on the latch members 22, and a recess 28 formed on the closure 14. As long as the projections 26 are engaged with the recess 28, the closure 14 is prevented from displacing, and the passage 12 remains blocked.

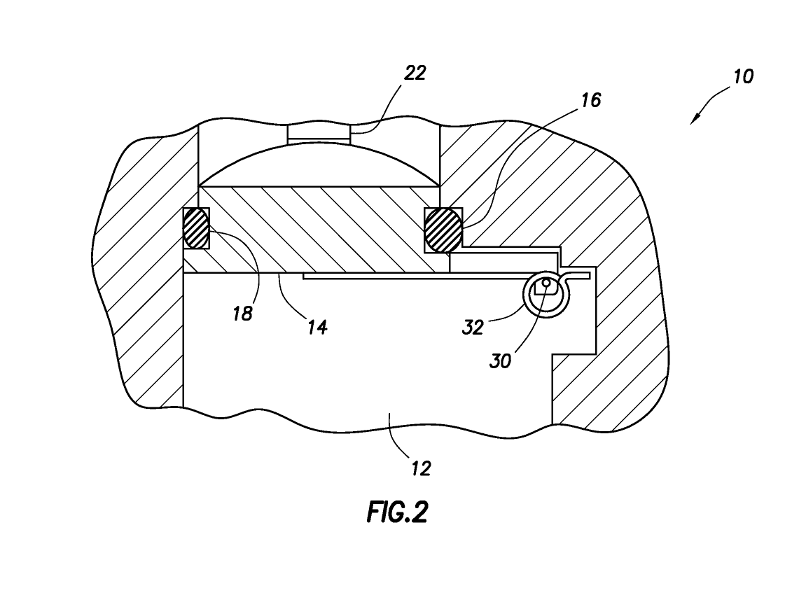

Referring additionally now to FIG. 2, another cross-sectional view of the fuel receptacle 10 is representatively illustrated. In this view, it may be seen that the closure 14 is in the form of a flapper which rotates about a pivot 30.

A torsion spring 32 maintains the closure 14 in its pivoted upward closed position. In this position, the seal 16 remains engaged with the seat 18, preventing flow through the passage 12.

It will be appreciated that, in order to introduce a fuel additive from a container into the fuel receptacle 10, the lock 20 should be disengaged (e.g., spreading apart the latch members 22, so that the projections 26 disengage from the recess 28), and the closure 14 should be displaced to an open position (e.g., whereby flow through the passage 12 is permitted).

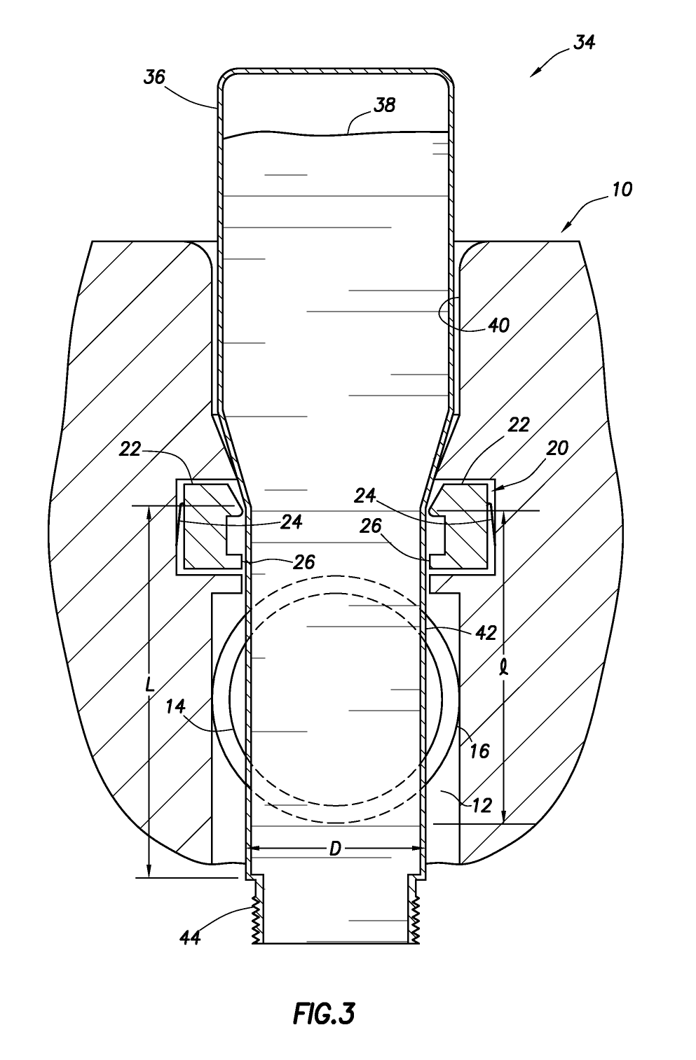

Referring additionally now to FIG. 3, a fuel additive system 34 which can embody principles of this disclosure is representatively illustrated. In this example, the system 34 includes a container 36 having a fuel additive 38 therein.

The fuel additive 38 could be any type of additive or treatment for fuel stored in a reservoir, such as a fuel tank. Fuel additives may include octane boosters, fuel injector cleaners, carburetor cleaners, engine lubricants, etc.

The container 36 is depicted in an inverted position, in which the container is inserted into an opening 40 of the fuel receptacle 10. In this position, the fuel additive 38 can flow out of the container 36 via its neck 42, which extends through the lock 20 and past the closure 14.

The container 36 example depicted in FIG. 3 is in the form of a bottle having a cylindrical neck 42 (circular in lateral cross-section), but it should be understood that other configurations may be used, if desired. For example, the neck 42 is not necessarily circular, it could instead be hexagonal, octagonal, oval, etc.

When the container 36 is inserted into the fuel receptacle 10, the neck 42 overcomes the biasing force exerted by the springs 24 and pushes the latch members 22 apart, thereby releasing the lock 20. Further insertion of the container 36 into the fuel receptacle 10 causes the neck 42 to contact the closure 14, overcome the biasing force exerted by the torsion spring 32, and pivot the closure downward to its open position as depicted in FIG. 3.

The neck 42 preferably has a length L of at least approximately 61.214 mm (˜2.410 in.), for use with the fuel receptacle 10 having a length l from the latch members 22 to the open closure 14, with length L preferably (but not necessarily) being greater than length l.

Of course, different lengths L may be used in keeping with the principles of this disclosure. However, if the length L is too short, the neck 42 may not effectively disengage the lock 20 and retain the closure 14 in its fully open position.

The neck 42 preferably has a lateral dimension D which is large enough to sufficiently spread apart the latch members 22, and small enough to fit into the passage 12. Preferably, the neck 42 is cylindrical shaped, with a diameter from approximately 21.488 mm (˜0.846 in.) to approximately 21.640 mm (˜0.852 in.), for use with latch members 22 initially spaced apart by a lateral dimension d (see FIG. 1) of approximately 19.685 mm (˜0.775 in.).

Of course, different lateral dimensions D of the neck 42 may be used in keeping with the principles of this disclosure. However, if the lateral dimension D is too small, the neck 42 may not effectively disengage the lock 20 by spreading apart the latch members 22. If the lateral dimension D is too large, the neck 42 may not fit into the entry passage 12.

The neck 42 may be provided with threads 44 for attaching a cap to close off the neck. If the threads 44 have a large enough diameter, their length could be included in the length L.

Threads 44 preferably have a flat crest 46 at their major diameter (see FIG. 5). The flat crest 46 prevents the threads 44 from catching on the latch members 22, closure 14 and various shoulders, etc. in the fuel receptacle 10 as the neck 42 is inserted and removed from the fuel receptacle.

Although in the example depicted in FIGS. 1-3, the container 36 is inverted to flow the fuel additive 38 into the passage 12, in other examples, the additive could be flowed into the passage 12 without inverting the container. For example, the container 36 and fuel receptacle 10 could be inclined at any point between horizontal and vertical orientations, etc.

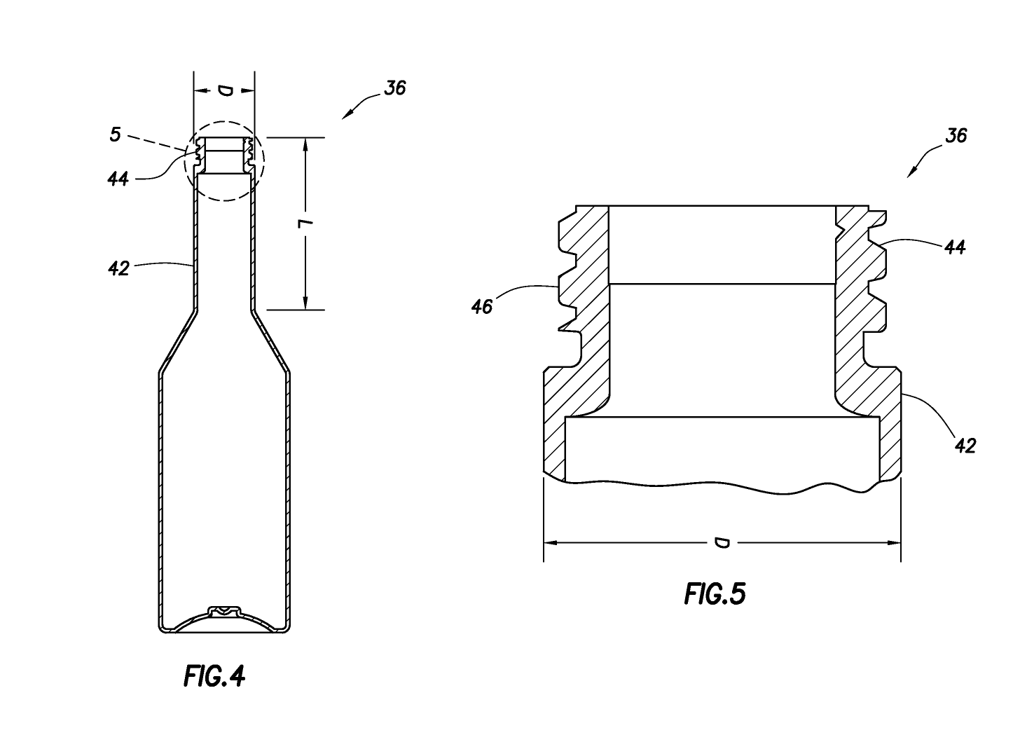

Referring additionally now to FIG. 4, a cross-sectional view of one configuration of the container 36 is representatively illustrated. In this view, it may be seen that the length L includes the length of the threads 44, since the threads are of appropriate dimensions to spread apart the latch members 22 and maintain the closure 14 in its open position.

In this example, the length L of the neck 42 is preferably about 61.341 mm (˜2.415 in.), and the lateral dimension D is preferably about 21.488 mm (˜0.846 in.). Of course, other dimensions may be used and still remain within the scope of this disclosure.

Referring additionally now to FIG. 5, an enlarged scale cross-sectional view of the threads 44 is representatively illustrated. In this view, it may be seen that the threads 44 have a flat crest 46, that is, the threads have a generally cylindrical major diameter surface. The flat crest 46 provides for convenient and effective insertion of the neck 42 into the receptacle 10, and subsequent removal of the neck from the receptacle.

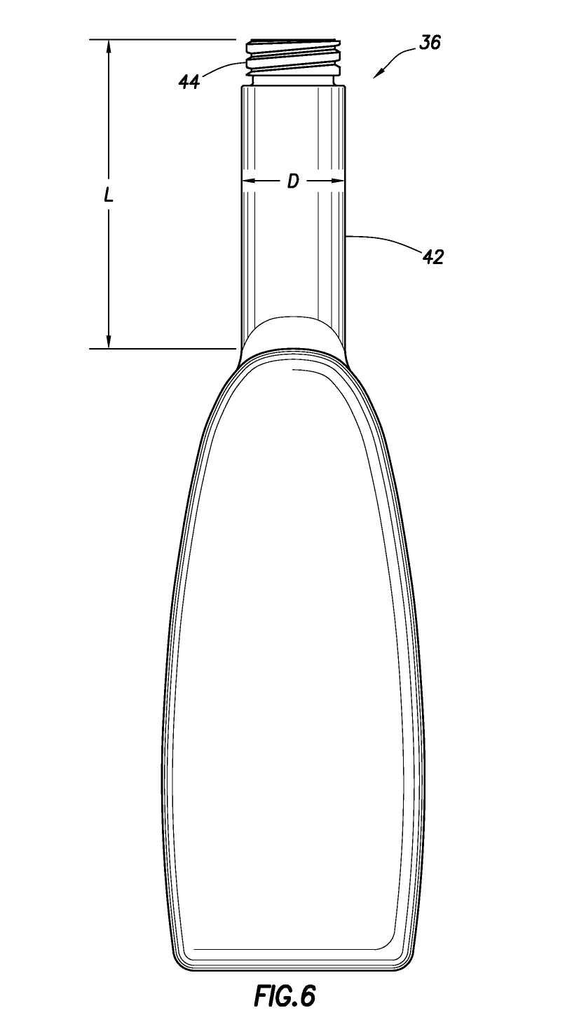

Referring additionally now to FIG. 6, another configuration of the container 36 is representatively illustrated. In this configuration, the length L again includes the length of the threads 44. The threads 44 in this example may have a lateral dimension (e.g., major diameter) the same as, or substantially equal to, the neck 42 lateral dimension D.

In this example, the length L is preferably about 64.44 mm (˜2.537 in.), and the lateral dimension D is preferably about 21.49 mm (˜0.846 in.). Of course, other dimensions may be used and still remain within the scope of this disclosure.

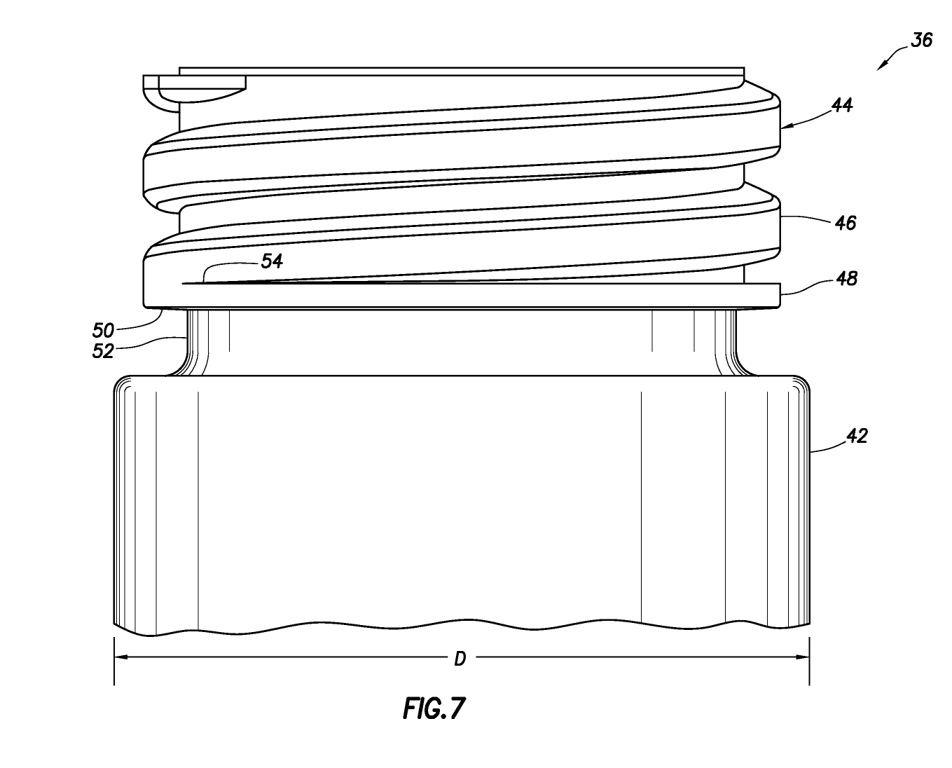

Referring additionally now to FIG. 7, an enlarged scale elevational view of the threads 44 on the FIG. 6 container 36 are representatively illustrated. In this view, it may be seen that the threads 44 terminate at a cylindrical shoulder 48 that is circumferentially continuous.

The shoulder 48 has a surface 50 facing an annular recess 52 between the shoulder and the neck 42. The surface 50 is circumferentially continuous and thereby provides for automated handling in a manufacturing facility (for example, for conveying the container 36 after it is formed, for supporting the container while it is being filled, etc.).

Note that a termination 54 of the threads 44 results in the thread crest 46 merging with the shoulder 48. In the FIG. 7 example, the thread crest 46 is wider than the shoulder 48, but in other examples widths of the thread crest and shoulder may be the same, or the shoulder may be wider than the thread crest.

It may now be fully appreciated that this disclosure provides several advancements to the art of constructing containers for dispensing products such as fuel additives into fuel receptacles. In examples described above, the threads 44 of the container 36 are configured to aid in disengaging the lock 20, to provide for ease in inserting and removing the container into/from the fuel receptacle 10, and to provide for automated handling of the container.

The above disclosure provides to the art a container 36 for dispensing into a fuel receptacle 10. In one example, the container 36 can comprise a neck 42 through which a product (such as, a fuel additive 38, etc.) is flowed. The neck 42 disengages a lock 20 which secures a closure 14 of the fuel receptacle 10, in response to insertion of the container 36 into the fuel receptacle 10. The container 36 further comprises threads 44 which merge with a circumferentially continuous shoulder 48 spaced apart from the neck 42.

A crest 46 of the threads 44 may merge with the shoulder 48 at a termination 54 of the threads 44.

The shoulder 48 can comprise a circumferentially continuous surface 50. The surface 50 may face an annular recess 52. The recess 52 may be positioned between the shoulder 48 and the neck 42.

The threads 44 can have a major diameter substantially equal to an outer lateral dimension D of the neck 42. The threads 44 may have a flat crest 46.

Insertion of the container 36 into the fuel receptacle 10 can cause displacement of the closure 14.

A container 36 is also provided to the art by the above disclosure. In one example, the container 36 can include a neck 42 through which a product is flowed, and threads 44 which merge with a circumferentially continuous shoulder 48 spaced apart from the neck 42, the shoulder 48 comprising a circumferentially continuous surface 50 that faces an annular recess 52 separating the shoulder 48 from the neck 42.

The neck 42 can disengage a lock 20 which secures a closure 14 of a fuel receptacle 10, in response to insertion of the container 36 into the fuel receptacle 10. Insertion of the container 36 into the fuel receptacle 10 may cause displacement of the closure 14.

A method of discharging a fuel additive 38 into a fuel receptacle 10 is also described above. In one example, the method comprises: containing the fuel additive 38 in a container 36, the container comprising a neck 42 through which the fuel additive 38 can flow, and threads 44 which merge with a circumferentially continuous shoulder 48 spaced apart from the neck 42 by an annular recess 52; inserting the container 36 into the fuel receptacle 10, whereby the neck 42 disengages a lock 20 which secures a closure 14 of the fuel receptacle 10; and discharging the fuel additive 38 from the container 36 into the fuel receptacle 10 via the neck 42.

The inserting step can include the threads 44 contacting and displacing the closure 14.

It is to be understood that the various examples described above may be utilized in various orientations, such as inclined, inverted, horizontal, vertical, etc., and in various configurations, without departing from the principles of the present disclosure. The embodiments illustrated in the drawings are depicted and described merely as examples of useful applications of the principles of the disclosure, which are not limited to any specific details of these embodiments.

Of course, a person skilled in the art would, upon a careful consideration of the above description of representative embodiments, readily appreciate that many modifications, additions, substitutions, deletions, and other changes may be made to these specific embodiments, and such changes are within the scope of the principles of the present disclosure. Accordingly, the foregoing detailed description is to be clearly understood as being given by way of illustration and example only, the spirit and scope of the present invention being limited solely by the appended claims and their equivalents.

What is claimed is:

1. A container for dispensing into a fuel receptacle, the container comprising:
a neck through which a product is flowed, wherein the neck disengages a lock which secures a closure of the fuel receptacle, in response to insertion of the container into the fuel receptacle; and
threads which merge with a circumferentially continuous shoulder spaced apart from the neck.

2. The container of claim 1, wherein a crest of the threads merges with the shoulder at a termination of the threads.

3. The container of claim 1, wherein the shoulder comprises a circumferentially continuous surface.

4. The container of claim 3, wherein the surface faces an annular recess.

5. The container of claim 4, wherein the recess is positioned between the shoulder and the neck.

6. The container of claim 1, wherein the threads have a major diameter substantially equal to an outer lateral dimension of the neck.

7. The container of claim 1, wherein the threads have a flat crest.

8. The container of claim 1, wherein insertion of the container into the fuel receptacle causes displacement of the closure.

9. A container, comprising:
a neck through which a product is flowed; and
threads which merge with a circumferentially continuous shoulder spaced apart from the neck, the shoulder comprising a circumferentially continuous surface that faces an annular recess separating the shoulder from the neck.

10. The container of claim 9, wherein a crest of the threads merges with the shoulder at a termination of the threads.

11. The container of claim 9, wherein the threads have a major diameter substantially equal to an outer lateral dimension of the neck.

12. The container of claim 9, wherein the threads have a flat crest.

13. The container of claim 9, wherein the neck disengages a lock which secures a closure of a fuel receptacle, in response to insertion of the container into the fuel receptacle, and wherein insertion of the container into the fuel receptacle causes displacement of the closure.

14. A method of discharging a fuel additive into a fuel receptacle, the method comprising:
containing the fuel additive in a container, the container comprising a neck through which the fuel additive can flow, and threads which merge with a circumferentially continuous shoulder spaced apart from the neck by an annular recess;
inserting the container into the fuel receptacle, whereby the neck disengages a lock which secures a closure of the fuel receptacle; and
discharging the fuel additive from the container into the fuel receptacle via the neck.

15. The method of claim 14, wherein a crest of the threads merges with the shoulder at a termination of the threads.

16. The method of claim 14, wherein the shoulder comprises a circumferentially continuous surface.

17. The method of claim 16, wherein the surface faces the annular recess.

18. The method of claim 14, wherein the threads have a major diameter substantially equal to an outer lateral dimension of the neck.

19. The method of claim 14, wherein the threads have a flat crest.

20. The method of claim 14, wherein the inserting comprises the threads contacting and displacing the closure.
